(19) United States
(12) Patent Application Publication
(10) Pub. No.: US 2002/0165832 A1
(43) Pub. Date: Nov. 7, 2002

(54) Product information management system

(75) Inventor: Kiyoshi Kawaguchi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/013,871

(22) Filed: Dec. 13, 2001

(30) Foreign Application Priority Data
May 2, 2001 (JP) 2001-134860

(51) Int. Cl. G06F 17/60

(52) U.S. Cl. 705/400

(57) ABSTRACT

a shared product database for storing product information capable of being utilized by all of a plurality of retailers is provided. And product information to be registered in one's own product database can be prepared efficiently and in a short period of time by respective retailers using the product information already registered in the shared product database. The aggressive registration of product information in the shared product database can be promoted by making it so that a predetermined utilization fee is paid to the retailer that registered product information in the shared product database, when that shared product database-registered product information is utilized.

### BACKGROUND OF THE INVENTION

1. Field of the Invention

The present invention is related to a product information management system for managing product information related to products handled by department stores, supermarkets and other retailers, and more particularly to a product information management system for managing the information of products handled in common by a plurality of different retailers.

2. Description of the Related Art

POS (Point of Sales) systems for managing product sales information are widely used by retailers. A POS system, also called a point of sales information management system, collects information in single item units at the time of sale to determine what products were sold, when and in what quantities, collects, stores and analyzes sales data for each product, and is capable of rapidly determining what products are popular. Further, the information obtained in this manner can also be used in sales management, inventory management and purchasing management.

For example, a POS terminal, such as a barcode reader, handy terminal or electronic cash register, for reading the barcodes attached to the price tags of products, transmits the read barcode information to a product database called a product master, via a computer called a store controller. A product databases is a database for storing product information, such as the product name and sales price of each product, and in addition to recording sales data from POS terminals, also returns product information, such as the sales price of a product corresponding to the received barcode information, to POS terminals.

This product database is ordinarily provided at each retailer, and each retailer creates and registers, in its respective product database, product information (product names, sales prices, suppliers) of products which it sells itself. The registering of product information is performed at each retailer by an operator operating a prescribed terminal and inputting product information regarding each product into the product database.

Now, this was inefficient because the product database of each retailer was only used inside that retailer, making it necessary for each retailer, respectively, to perform the task of registering product information in the product database for the same products.

### SUMMARY OF THE INVENTION

Accordingly, an object of the present invention is to provide a product information management system for efficiently registering product information in product databases at respective retailers.

To achieve the above object, a product information management system in the present invention for managing product information registered in the respective product databases of a plurality of retailers comprises:

a shared product database for storing product information capable of being utilized by all of the plurality of retailers; and

a controller for registering a first product information prepared by a first retailer for a predetermined product in the shared product database, and outputting the first product information to a terminal managed by a second retailer.

Preferably, the controller registers a second product information for the predetermined product, which was prepared by the second retailer using the first product information, in a product database of the second retailer, when acquiring the second product information from a terminal managed by the second retailer.

Preferably, the controller registers the first product information in the shared product database, and also registers same in a product database of the first retailer, when acquiring the first product information in case that product information for the predetermined product is not registered in the shared product database.

Preferably, the first product information includes at least information common to respective retailers.

Preferably, the second product information includes the first product information, and information peculiar to the second retailer.

Preferably, regarding the utilization of product information registered in the shared product database, the controller calculates an amount to be charged on a retailer which utilized this registered product information, for each retailer.

Preferably, regarding the utilization of product information registered in the shared product database, the controller calculates an amount to be paid to a retailer which registered this utilized product information, for each retailer.

### BRIEF DESCRIPTION OF THE DRAWINGS

FIG. 1 is a diagram showing an example of a constitution of a product information management system of an aspect of the embodiment of the present invention;

FIGS. 2A, 2B, 2C, 2D and 2E are diagrams showing examples of data configurations stored in respective databases;

FIG. 3 is a processing flowchart of a product information management system of an aspect of the embodiment of the present invention;

FIG. 4 is an example of a product code input screen displayed on the terminal 20 of a retailer;

FIG. 5 is an example of a screen on a retailer's terminal 20A, on which product information is being displayed;

FIG. 6 is an example of a screen on a retailer's terminal 20A, on which only common product information is being displayed; and

FIG. 7 is a diagram showing an example of another constitution of a product information management system of an aspect of the embodiment of the present invention.

### DESCRIPTION OF THE PREFERRED EMBODIMENTS

The aspects of the embodiment of the present invention will be explained hereinbelow. However, the technical scope of the present invention is not limited to these aspects of the embodiment.

In an aspect of the embodiment of the present invention, a shared product database, which a plurality of retailers can use, is provided, and each retailer uses product information already registered in the shared product database, and performs the task of registering product information in its own product database.

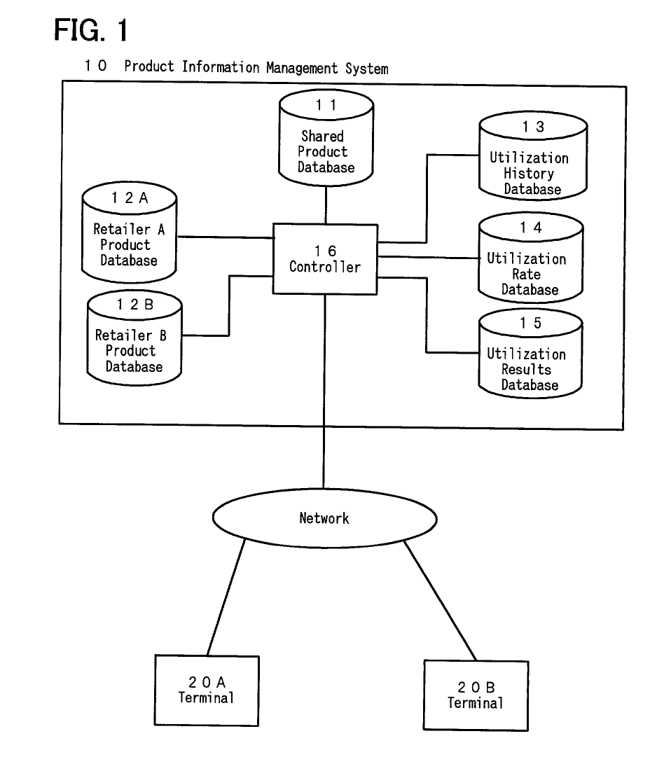

FIG. 1 is a diagram showing an example of a constitution of a product information management system of an aspect of the embodiment of the present invention. In FIG. 1, a product information management system 10 has a shared product database (shared product master) 11, a by-retailer product database (by-retailer product master) 12 (For example, for retailers A, B, there is a retailer A product database 12A, and a retailer B product database 12B, respectively.), a utilization history database 13, a utilization rate database 14, a utilization results database 15, and a controller 16 for controlling these databases. Controller 16 controls each type of database, and, in addition, communicates with a predetermined terminal 20 (In FIG. 1, retailer A terminal 20A and retailer B terminal 20B are illustrated.) at each of a plurality of retailers via a communications network.

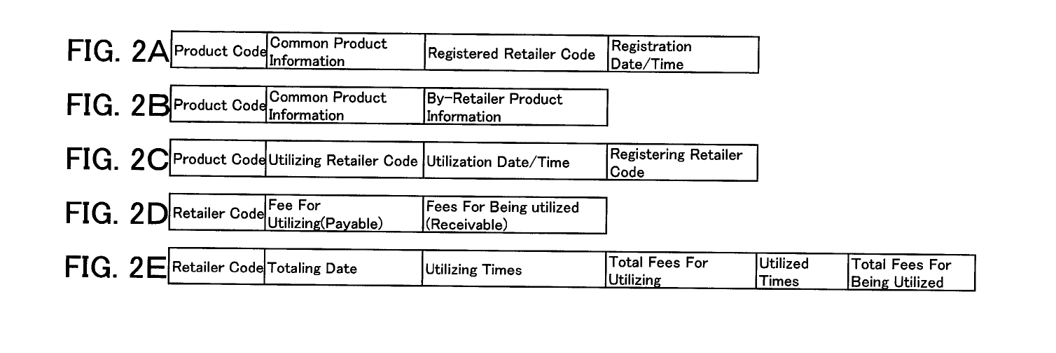

FIGS. 2A, 2B, 2C, 2D and 2E are diagrams showing examples of data configurations stored in respective databases. FIG. 2A is an example of the configuration of data stored in shared product database 11. Shared product database 11 comprises such data as (1) a product code for each product, (2) product information, which is common to a plurality of retailers, for each product (for example, product names, manufacturer's suggested retail prices, and so forth), (3) registered retailer code, and (4) registration date/time. The registering retailer code and registration date/time, as will be explained below, are the retailer code of the retailer, which registered this product information in shared product database 11, and registration date/time.

FIG. 2B is an example of the configuration of data stored in respective by-retailer product databases 12. A by-retailer product database 12 comprises data, such as (1) a product code for each product, (2) the above-mentioned common product information, and (3) product information of respective retailers (for example, sales prices, unit prices, and suppliers).

FIG. 2C is an example of the configuration of data stored in utilization history database 13, which data comprises (1) product codes, (2) the retailer codes of the retailers that utilize this product data stored in the shared product database (utilising retailer codes), (3) utilization date/time, and (4) retailer codes of retailers that registered this product data in shared product database 11 (registering retailer codes).

FIG. 2D is an example of the configuration of data stored in utilization rate database 14, which data comprises (1) retailer codes, (2) per-usage utilization fees when data, which another retailer registered in shared product database 11, is used (fees for utilizing (payable)), and (3) per-usage utilization fees when data, which the retailer itself registered in shared product database 11, is used (fees for being utilized (receivable)).

FIG. 2E is an example of the configuration of data stored in utilization results database 15, which data comprises (1) retailer codes, (2) totaling date (year, month, day), (3) number of times that data registered in shared product database 11 by other retailers was utilized during a predetermined period (utilizing times), (4) total fees for utilizing, determined by multiplying the per-usage fees for utilizing, stored in the above-mentioned utilization rate database by this utilizing times, (5) number of times that data registered in shared product database 11 by the retailer itself was utilized during a predetermined period (utilized times), and (6) total fees for being utilized, determined by multiplying the per-usage fees for being utilized, stored in the above-mentioned utilization rate database by this utilized times.

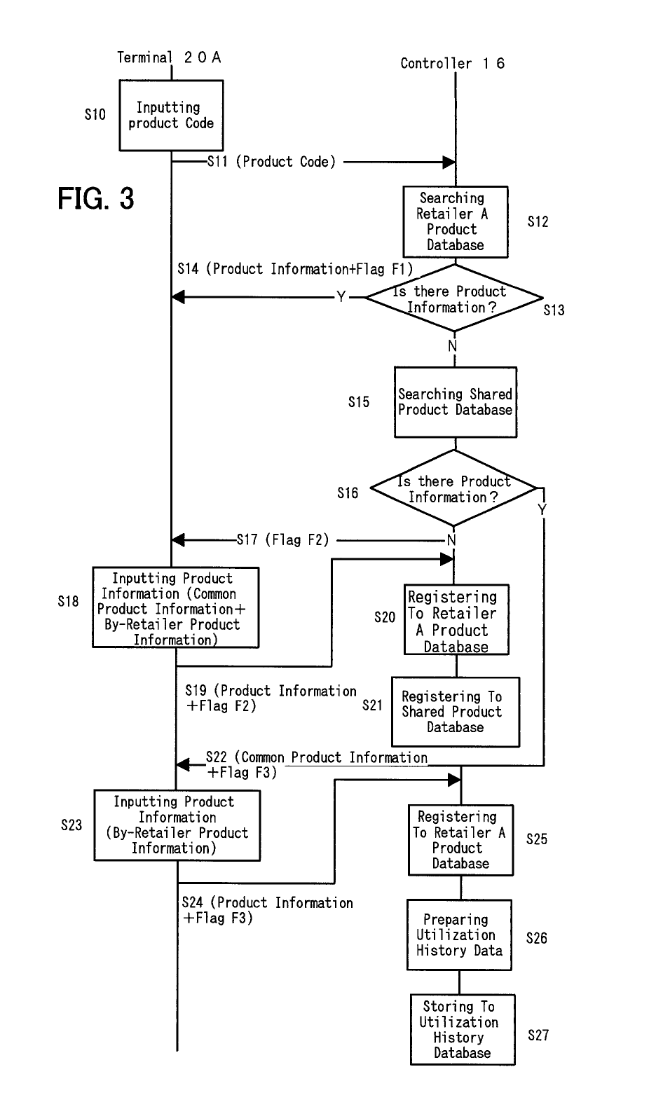

FIG. 3 is a processing flowchart of a product information management system of an aspect of the embodiment of the present invention. FIG. 3 describes an example of the processing between terminal 20A of retailer A and controller 16 of the product information management system. First of all, to ascertain whether product information on a certain product is registered in the product database 12A of retailer A, terminal 20A inputs the product code of this product (S10) and accesses controller 16 (S11).

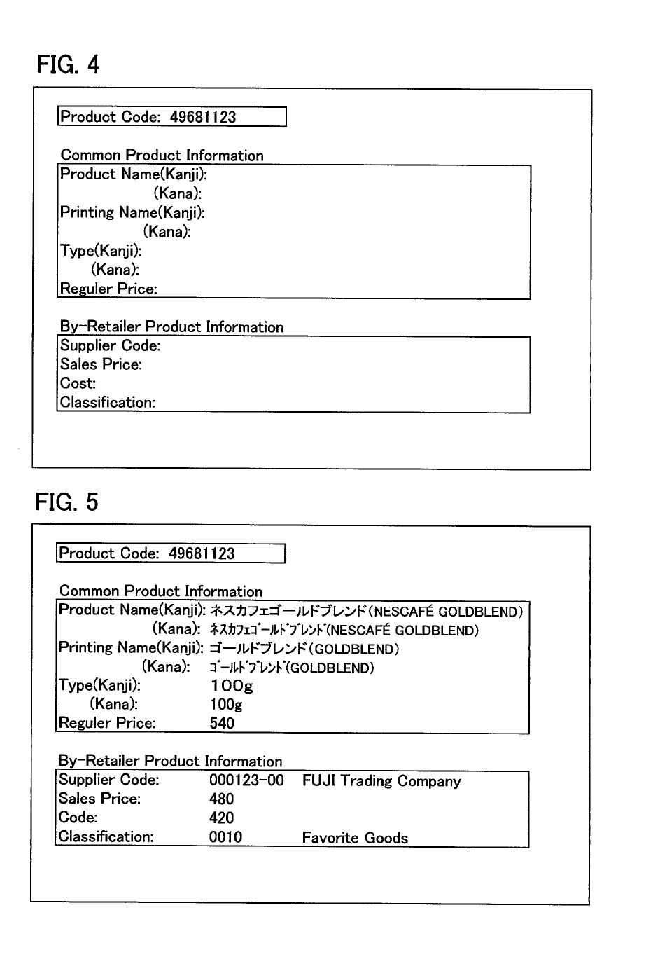

FIG. 4 is an example of a product code input screen displayed on retailer terminal 20A. In FIG. 4, the inputted product code is displayed, but common product information and by-retailer product information are not displayed yet.

Controller 16 searches the product database 12A of retailer A using the received product code (S12), and in Step S13, when product information corresponding to the product code is resident in retailer A product database 12A (common product information+by-retailer product information), reads out this product information and returns it terminal 20A (S14). In this case, controller 16 sends the product information to terminal 20A with a flag F1 attached.

FIG. 5 is an example of a terminal 20A screen, on which product information is being displayed. In FIG. 5, both common product information and by-retailer product information are displayed. When there are revisions to prescribed items, such as sales price, an operator performs revision processing. Then, by sending a registration command together with the revised product information and flag F1 from terminal 20A to controller 16, controller 16 executes update processing of the product information (common product information+by-retailer product information) in product database 12A of retailer A. The common product information of shared product database 11 is not updated at this time.

Meanwhile, in Step S13, when product information corresponding to a product code is not resident in retailer A product database 12A, controller 16 also searches shared product database 11 using this product code (S15).

In Step S16, when product information corresponding to this product code is not resident in shared product database 11, controller 16 sends a flag F2 indicative of a case in which product information is not resident in either by-retailer product database 12A or shared product database 11 (S17). In this case, the screen of terminal 20A is a state, wherein product information is not inputted, the same as FIG. 4.

The operator of terminal 20A inputs both common product information and by-retailer product information (S18). Then, a registration command is sent from terminal 20A to controller 16, together with product information and flag F2 (S19). Controller 16 registers the received product information (common product information+by-retailer product information) in retailer A product database 12A according to the data configuration of FIG. 2B (S20), and, in addition, registers common product information in shared product database 11 according to the data configuration of FIG. 2A (S21). In this case, the registering retailer code for the data of FIG. 2A is the retailer code of retailer A.

With regard to a product, which has yet to be registered in shared product database 11, in an aspect of the embodiment of the present invention, when a certain retailer initially registers this product information in its own by-retailer product database 12, the common product information of the product information is automatically registered in shared product database 11 in this fashion. So as to be able to identify the retailer, which initially registered the common product information of this product in shared product database 11, a retailer code related to this common product information is also registered at this time.

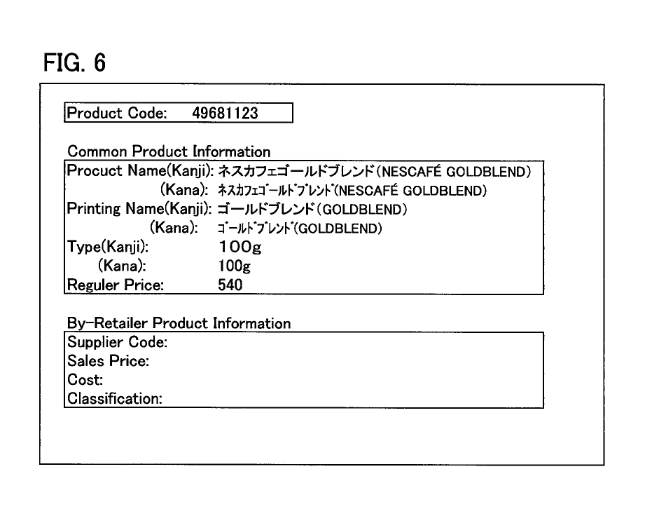

Meanwhile, when common product information corresponding to this product code is registered in shared product database 11 in Step S16, controller 16 reads out this common product information and returns it to terminal 20A (S22). In this case, controller 16 sends common product information to terminal 20A with a flag F3 attached. FIG. 6 is an example of a terminal 20A screen on which only common product information is displayed.

In the screen of FIG. 6, since it is a state, wherein common product information is already being displayed, that is, an inputting complete state, the operator operating terminal 20A need only input by-retailer product information.

By-retailer product information is inputted (S23), and a registration command is sent to controller 16 from terminal 20A (S24) together with product information and flag F3. When this happens, controller 16 registers the received product information in retailer A product database 12A according to the data configuration of FIG. 2B (S25), and, in addition, prepares utilization history data according to the data configuration of FIG. 2C (S26), and stores this in utilization history database 13 (S27).

As for the utilization history data prepared in Step S26, when the user retailer code thereof in the utilization history data in FIG. 2C is the retailer code of retailer A, and the retailer, which registered the common product information of this product in shared product database 11, is retailer B, the registering retailer code is the retailer code of retailer B. Retailer B can prepares the common product information by operating the terminal 20B.

In this fashion, according to this aspect of the embodiment, when a certain retailer registers product information regarding a certain product, if common product information concerning this product is already registered in shared product database 11, this is read out and supplied to the terminal, which inputted the product information. Consequently, the work of inputting common product information can be omitted, registration work can be reduced, and registration time can be shortened.

Then, in this aspect of the embodiment, when common product information registered in shared product database 11 is utilized, the retailer, which utilized this common product information, pays a predetermined utilization fee, and when common product information registered in shared product database 11 is utilized, the retailer, which registered this common product information in shared product database 11, can receive a predetermined utilization fee. In this way, by providing a monetary advantage to the retailer, which initially registers common product information in shared product database 11, it is possible to promote the aggressive registration of product information.

As explained hereinabove, utilization history data is prepared every time common product information is used, and controller 16 of the product information management system totals the utilization history data of FIG. 2C at each predetermined period, calculates the total fees for utilizing (payments) and the total fees for being utilized (revenues) for each retailer, respectively, and prepares the utilization results data of FIG. 2E.

For example, in the utilization rate database of FIG. 2D, when there are registered for retailer A,

Per-usage fees for utilizing: 100 yen

Per-usage fees for being utilized: 90 yen and, in a predetermined period (for example, one month), when there are:

Number of times common product data registered by other retailers was used (utilizing times): 50

Number of times common product data registered by retailer A itself was used (utilized times): 60, this works out to:

Total fees for utilizing (payments): 100×50=5000 yen

Total fees for being utilized (revenues): 90×60=5400 yen and retailer A earns revenues of the balance of 400 yen.

Shared product database utilization-related earnings/expenditures determined in this way can be adjusted together with utilization fees for the product information management system. For example, when the overall utilization fee for the product information management system for one month is 10,000 yen, and earnings/expenditures related to the utilization of shared product database 11 as explained hereinabove result in revenues of 400 yen, then retailer A can pay a utilization charge for that month of:

10,000−400=9600 yen

Thus, controller 16 of the product information management system, regarding the use of product information registered in shared product database 11, calculates fees for utilizing charged on retailers, which utilized registered product information, and also fees for being utilizing paid to retailers, which registered utilized product information, for each retailer.

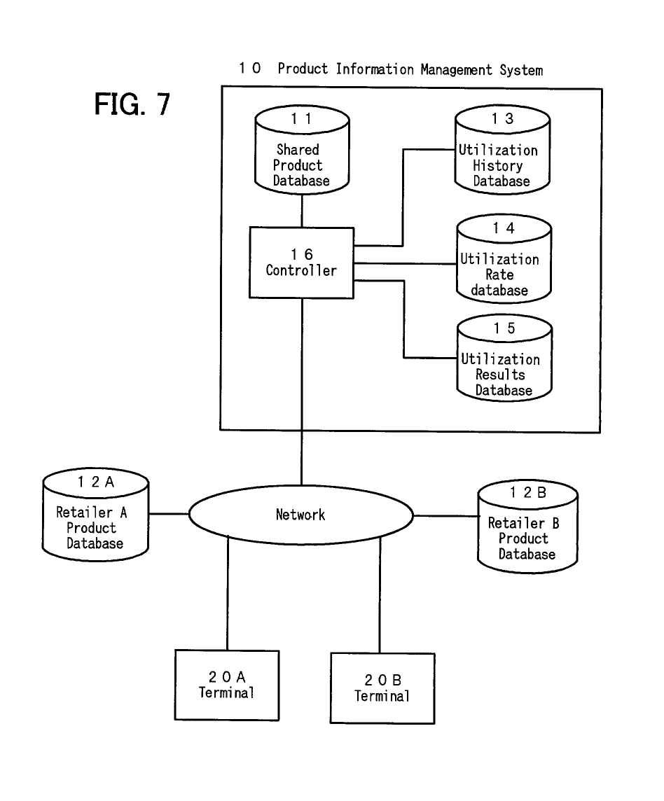

FIG. 7 is a diagram showing an example of another configuration of a product information management system in an aspect of the embodiment of the present invention. In the above-mentioned aspect of the embodiment, the product information management system was constituted comprising a by-retailer product database 12 for each retailer, but as shown in the configuration example of FIG. 7, the respective by-retailer product database 12 can each be provided independently. In this case, controller 16 of the product information management system will access each by-retailer product database 12, and execute the processing of the above-mentioned aspect of the embodiment via a communications network.

According to the present invention described hereinabove, a shared product database for storing product information capable of being utilized by all of a plurality of retailers is provided. And product information to be registered in one's own product database can be prepared efficiently and in a short period of time by respective retailers using the product information already registered in the shared product database. The aggressive registration of product information in the shared product database can be promoted by making it so that a predetermined utilization fee is paid to the retailer that registered product information in the shared product database, when that shared product database-registered product information is utilized.

The scope of protection of the present invention is not limited to the above-mentioned aspects of the embodiment, but rather extends to the inventions disclosed in the claims and the equivalents thereof.

What is claimed is:

1. A product information management system for managing product information registered in the respective product databases of a plurality of retailers, said product information management system comprising:
a shared product database for storing product information capable of being utilized by all of said plurality of retailers; and
a controller for registering a first product information prepared by a first retailer for a predetermined product in said shared product database, and outputting said first product information to a terminal managed by a second retailer.

2. The product information management system according to claim 1, wherein said controller registers a second product information for said predetermined product, which was prepared by said second retailer using said first product information, in a product database of said second retailer, when acquiring said second product information from a terminal managed by said second retailer.

3. The product information management system according to claim 1, wherein said controller registers said first product information in said shared product database, and also registers same in a product database of said first retailer, when acquiring said first product information in case that product information for said predetermined product is not registered in said shared product database.

4. The product information management system according to claim 1, wherein said first product information includes at least information common to respective retailers.

5. The product information management system according to claim 2, wherein said second product information includes said first product information, and information peculiar to said second retailer.

6. The product information management system according to claim 1, wherein, regarding the utilization of product information registered in said shared product database, said controller calculates an amount to be charged on a retailer which utilized this registered product information, for each retailer.

7. The product information management system according to claim 1, wherein, regarding the utilization of product information registered in said shared product database, said controller calculates an amount to be paid to a retailer which registered this utilized product information, for each retailer.

8. A terminal of a first retailer for preparing product information to be registered in a product database via a communication network, said terminal comprising:
a communicating unit for receiving a first product information corresponding to a predetermined product registered in a shared product database which is capable of being utilized by a plurality of retailers, said first product information being prepared by a second retailer; and
a displaying unit for displaying said first product information; and
an inputting unit for preparing a second product information for said predetermined product by using said first product information.

9. The terminal according to claim 8, wherein said first product information includes at least information common to respective retailers.

10. The terminal according to claim 8, wherein said second product information includes said first product information, and information peculiar to said second retailer.
